(19) United States
(12) Patent Application Publication
(10) Pub. No.: US 2006/0214914 A1
(43) Pub. Date: Sep. 28, 2006

(54) Mouse

(75) Inventor: Ling Yu Chiang, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/386,672

(22) Filed: Mar. 23, 2006

(30) Foreign Application Priority Data
Mar. 24, 2005 (TW) 094109175

(51) Int. Cl. G09G 5/08

(52) U.S. Cl. 345/163

(57) ABSTRACT

A mouse is used for a computer having data. The mouse includes a data saving module, a pointing module, a wireless communicating module and a control module. The pointing module detects a position of the mouse to generate an input message. The wireless communicating module communicates with the computer via a wireless transmission protocol. The control module electrically connects with the data saving module, the pointing module and the wireless communicating module, and is able to control the wireless communicating module to send the input message to the computer, to receive the data from the computer via the wireless communicating module and save the data to the data saving module, or to send the data stored in the data saving module to the computer.

### BACKGROUND OF THE INVENTION

1. Field of Invention

The invention relates to a mouse and, in particular, to a mouse having a data saving function.

2. Related Art

A mouse is one of the basic computer peripheral apparatuses for operating a computer or inputting data to the computer. When the user interface of the computer is a window graphic user interface, the mouse is the best pointing device for the computer.

As shown in FIG. 1, a mouse 11 has to be used for a computer 12, such as a portable computer, and the function of the mouse 11 is limited to input information to the portable computer 12.

The user carry data in the computer or listen to the music by the mobile storage device, such as the flash drive, or the mp3 player.

It is troublesome if the user has to carry many computer peripheral apparatuses. Thus, if the mobile storage device or the mp3 player can integrate into the basic computer peripheral apparatus, the number of computer peripheral apparatuses carried by the user can be reduced.

Thus, it is an important subject of the invention to provide multi-function computer peripheral apparatuses, as a device having a wireless communication function, a data saving function and a playing function, thus the user can conveniently use the computer and its peripheral apparatuses.

### SUMMARY OF THE INVENTION

In view of the foregoing, the invention provides a mouse capable of saving data and playing the data.

To achieve the above, an embodiment of the invention is a mouse includes a data saving module, a pointing module, a wireless communicating module and a control module. The pointing module generates an input message. The wireless communicating module communicates with the computer via a wireless transmission protocol. The control module, which electrically connects with the data saving module, the pointing module and the wireless communicating module, controls the wireless communicating module to send the input message to the computer, receive the data from the computer save the data to the data saving module, and send the data stored in the data saving module to the computer.

In summary, the mouse has the wireless communicating module and the data saving module, the mouse can receive the data from the computer via the wireless communicating module, and save the data via the data saving module. In addition, the mouse of the invention may also have the playing module for playing the multimedia data stored in the data saving module.

### BRIEF DESCRIPTION OF THE DRAWINGS

The invention will become more fully understood from the detailed description given herein below illustration only, and thus is not limitative of the present invention, and wherein:

FIG. 1 is a schematic illustration showing a conventional mouse;

FIG. 2 is an exploded view showing a mouse according to a preferred embodiment of the invention;

FIG. 3 is an exploded view showing the mouse according to the preferred embodiment of the invention, wherein a lower housing of the mouse includes a wired connection port; and

FIGS. 4A and 4B are oblique top and bottom views showing the mouse according to the preferred embodiment of the invention.

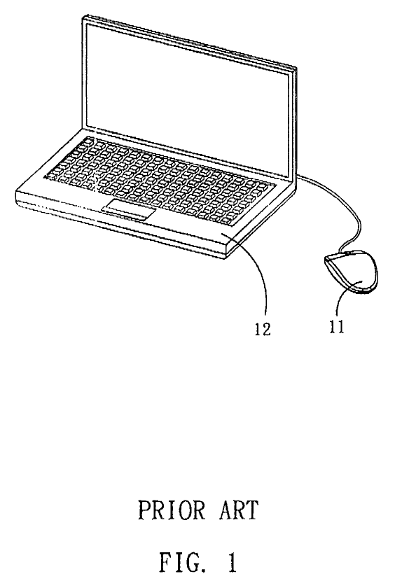

### DETAILED DESCRIPTION OF THE INVENTION

The present invention will be apparent from the following detailed description, which proceeds with reference to the accompanying drawings, wherein the same references relate to the same elements.

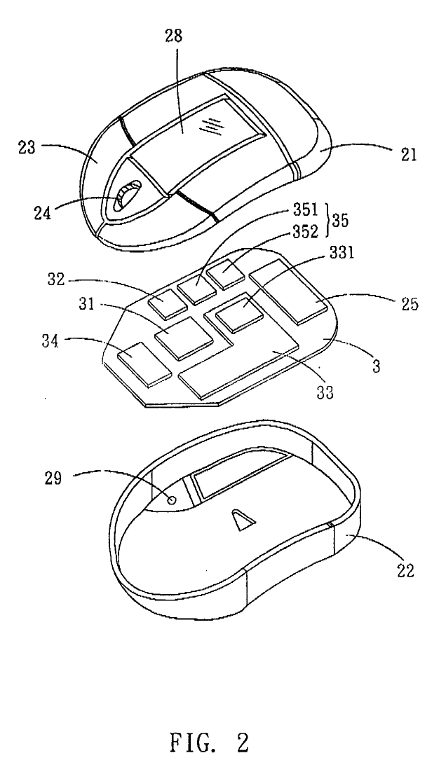

As shown in FIG. 2, a mouse according to a preferred embodiment of the invention is used for a computer. The computer has data stored therein. The mouse includes a control module 31, a data saving module 32, a pointing module 33 and a wireless communicating module 34.

The pointing module 33 detects a operation from the mouse to generate an input message. The wireless communicating module 34 communicates with the computer via a wireless transmission protocol. The control module 31, which electrically connects with the data saving module 32, the pointing module 33 and the wireless communicating module 34, controls the wireless communicating module 34 to send the input message to the computer, receive the data from the computer, save the received data to the data saving module 32, and to send the data stored in the data saving module 32 to the computer.

Referring again to FIG. 2, the mouse of this embodiment may further include an upper housing 21, a lower housing 22, a circuit board 3, a playing module 35 and a battery 25.

The control module 31, the data saving module 32, the pointing module 33, the wireless communicating module 34 and the playing module 35 are disposed on the circuit board 3. The upper housing 21 and the lower housing 22 may be combined to form a complete mouse housing. The circuit board 3, the control module 31, the data saving module 32, the pointing module 33, the wireless communicating module 34, the playing module 35 and the battery 25 are disposed in the mouse housing composed of the upper housing 21 and the lower housing 22. The battery 25 electrically connecting with the control module 31, the data saving module 32, the pointing module 33, the wireless communicating module 34 and the playing module 35 provides power for each module.

In addition, the pointing module 33 of this embodiment includes an optical sensing member 331. When the user moves the mouse, the position of the mouse may be detected by the optical sensing member 331. In addition, the optical sensing member 331 may also be replaced with a member, such as a track ball, capable of detecting the position of the mouse. On the other hand, the mouse of this embodiment in FIG. 2 includes at least one key 23 and a roller 24, both of which are disposed on the upper housing 21 such that the user can operate the mouse by way of single clicking, double clicking or scrolling.

The wireless communicating module 34 can communicate with the computer via a bluetooth transmission protocol, an infrared transmission protocol, or the wireless transmission protocols with other specifications. Thus, it is unnecessary to connect the mouse with the computer through a physical cable, and the wireless communicating module 34 can send the position of the mouse or the mode (e.g., a single clicking mode, a double clicking mode or a scrolling mode), in which the user operates the mouse, to the computer. In addition, the wireless communicating module 34 may further communicate with the computer or other wireless transmission apparatuses to send or receive the data. The received data may be saved to the data saving module 32. If the received data is the multimedia data, the data may be played by the playing module 35.

In addition, the playing module 35 of this embodiment has a data processing unit 351 and a playing unit 352. When the data stored in the data saving module 32 or the data received by the wireless communicating module 34 is the multimedia data, the data processing unit 351 decodes the multimedia data, and the playing unit 352 plays the decoded multimedia data. The multimedia data may be the compressed audio data, such as the audio data having the format of MP3 (MPEG Layer-3), AAC (Advanced Audio Coding), or WMA (Windows Media Audio), or the compressed video/audio data, such as the audio or the film having the format of MPEG (Moving Picture Experts Group), H.26x or WMV (Windows Media Video).

In this embodiment, the control module 31 may be a chip such as a microcontroller or a microprocessor. The data saving module 32 may be a random access memory or a flash memory. The wireless communicating module 34 may be a bluetooth communication chip or an infrared communication chip. The data processing unit 351 may be an MPEG decoding chip, or any type of decoding chip of the microprocessor. The playing unit 352 may be an audio chip.

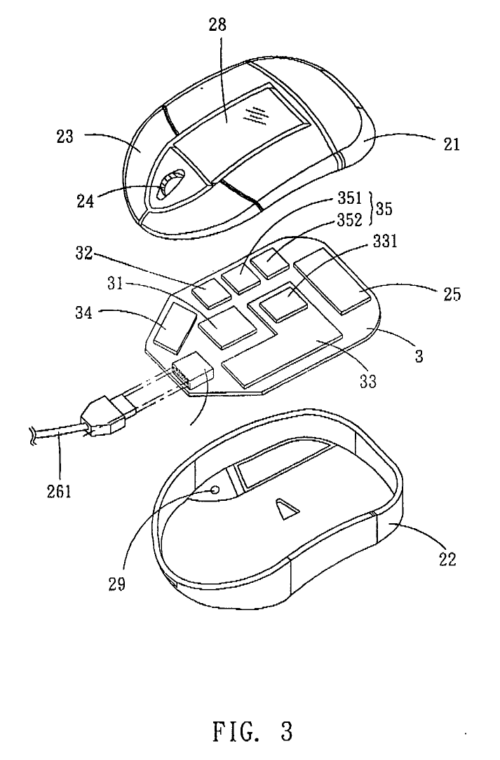

Referring to FIG. 3, the mouse may further include a wired connection port 26 disposed on the circuit board 3 and in correspondence with an opening of the lower housing 22. The wired connection port 26 electrically connects with the control module 31, and communicates with the computer via a transmission cable 261 and a universal serial bus (USB) transmission protocol or a wired transmission protocol. The control module 31 controls the wired connection port 26 to receive the data from the computer and save the data to the data saving module 32. In addition, if the battery 25 is a rechargeable battery, the battery 25 may also electrically connect with the wired connection port 26. When the wired connection port 26 connects with the computer via the transmission cable 261, the battery 25 may be recharged by the power transmitted from the computer to the wired connection port 26.

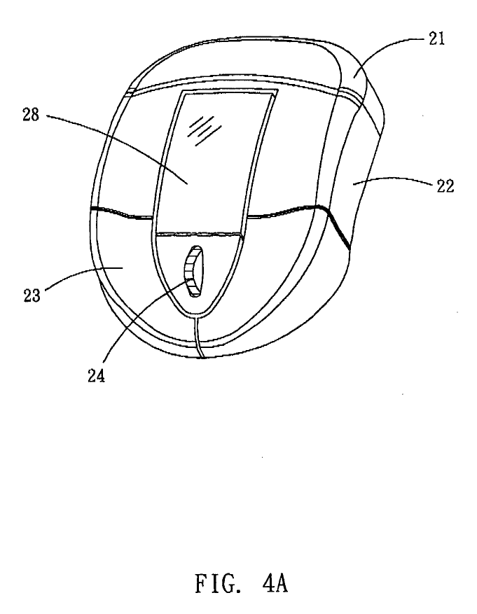

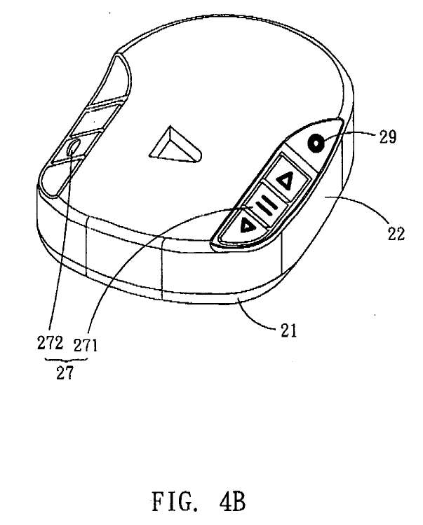

FIGS. 4A and 4B are oblique top and bottom views showing the mouse according to the preferred embodiment of the invention. The mouse according to the preferred embodiment of the invention further includes an input module 27, a display module 28 and an audio output port 29.

The input module 27 electrically connecting with the control module 31 is able to control the playing state of the playing module 35. The input module 27 includes at least one key 271 and a knob 272. The key 271 and the knob 272 are disposed on the lower housing 22. As shown in FIG. 4B, the keys 271 of the input module 27 may be the keys, such as the “play”, “stop”, “fast forward” or “rewind” keys, for playing media. The knob 272 may be rotated clockwise or counterclockwise. Thus, the user can operate the playing module 35 to play music or films through the keys. In addition, the user may also operate the keys 271 and the knob 272 to delete, select, or play the data stored in the data saving module 32.

The display module 28 electrically connects with the control module 31 and is disposed on the upper housing 21. The display module 28 can display the content (e.g., the text content, the MPEG film, or the like) corresponding to the data stored in the data saving module 32, the remained space of the data saving module 32, or the playing state of the playing module 35. The display module 28 may be a LED (Light Emitting Diode) display, an EL (Electro-Luminescence) display, an OLED (Organic Light Emitting Diode) display or a LCD (Liquid Crystal Display) display.

The audio output port 29 electrically connects with the playing unit 352 and is disposed on the lower housing 22. The audio output port 29 is to be connected to an audio outputting device, such as an external earphone or a speaker.

In addition, in another embodiment of the invention, the control module 31, the data saving module 32, the wireless communicating module 34, the data processing unit 351 and the playing unit 352 may be integrated in at least one chip in the aspect of hardware or firmware. If they are integrated in the aspect of firmware, the control module 31, the data saving module 32, the wireless communicating module 34, the data processing unit 351 and the playing unit 352 may be program codes.

As mentioned hereinabove, the user can operate the computer through the mouse, and the mouse may serve as a mobile disk because the mouse can receive the data from the computer via the wireless communicating module and save the data via the data saving module in this invention. When the user goes out and carries a portable computer and the mouse of this invention, he or she does not have to carry a mobile disk. Thus, the number of computer peripheral apparatuses to be carried by the user may be reduced.

In addition, the mouse of the invention may also have the playing module, so the mouse can play the multimedia data stored in the data saving module. Thus, the user can use this mouse as a mobile player or a mobile video/audio playing apparatus. The mouse capable of serving as the mobile disk and the mobile player enables the user to use the portable computer more conveniently.

In summary, the mouse of the invention has the wireless communicating module and the data saving module, the mouse can receive the data from the computer via the wireless communicating module, and save the data via the data saving module. In addition, the mouse of the invention may also have the playing module for playing the multimedia data stored in the data saving module.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A mouse used for a computer having data, the mouse comprising:
a data saving module;
a pointing module for detecting a operation of the mouse to generate an input message;
a wireless communicating module for communicating with the computer via a wireless transmission protocol; and
a control module, which electrically connects with the data saving module, the pointing module and the wireless communicating module, for controlling the wireless communicating module to send the input message to the computer, receive the data from the computer, save the data to the data saving module, and to send the data stored in the data saving module to the computer.

2. The mouse according to claim 1, further comprising:
a playing module, which electrically connects with the control module, for playing the data.

3. The mouse according to claim 2, wherein the playing module has:
a data processing unit for decoding the data, which is multimedia data; and
a playing unit for playing the decoded data.

4. The mouse according to claim 2, further comprising:
an input module, which electrically connects with the control module, for controlling a state in which the playing module plays the data.

5. The mouse according to claim 4, wherein the input module comprises at least one key.

6. The mouse according to claim 4, wherein the input module comprises a knob.

7. The mouse according to claim 4, further comprising:
a housing having an audio output port, wherein the control module, the data saving module, the pointing module, the wireless communicating module and the playing module are disposed in the housing.

8. The mouse according to claim 1, further comprising:
a battery, which electrically connects with the data saving module, the pointing module, the wireless communicating module and the control module.

9. The mouse according to claim 1, further comprising:
a display module, which electrically connects with the control module, for displaying a content of the data.

10. The mouse according to claim 1, wherein the control module receives the data of the computer via the wireless communicating module, saves the data to the data saving module, and sends the data stored in the data saving module to the computer.

11. The mouse according to claim 1, further comprising:
a wired connection module, which electrically connects with the control module, for communicating with the computer via a transmission cable and a wired transmission protocol, wherein the control module controls the wired connection module to receive the data from the computer and save the data to the data saving module.

12. The mouse according to claim 11, wherein the wired transmission protocol is a universal serial bus transmission protocol.

13. The mouse according to claim 1, further comprising:
a circuit board, on which the data saving module, the pointing module, the wireless communicating module and the control module are disposed.

14. The mouse according to claim 13, further comprising:
a housing, in which the control module, the data saving module, the pointing module, the wireless communicating module and the circuit board are disposed.

15. The mouse according to claim 14, further comprising:
an audio output port, which is disposed on the housing and to be connected to an audio outputting device.

16. The mouse according to claim 1, wherein the pointing module comprises a track ball.

17. The mouse according to claim 1, wherein the pointing module comprises an optical sensing member.

18. The mouse according to claim 1, wherein the wireless transmission protocol is a bluetooth transmission protocol.

19. The mouse according to claim 1, wherein the wireless transmission protocol is an infrared transmission protocol.
